(19) United States
(12) Patent Application Publication
(10) Pub. No.: US 2025/0378694 A1
(43) Pub. Date: Dec. 11, 2025

(54) LEARNING IMAGE GENERATION DEVICE, LEARNING IMAGE GENERATION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Hiroki Nishimura, Shinagawa-ku Tokyo-to (JP)

(73) Assignee: TOYOTA JIDOSHA KABUSHIKI KAISHA, Toyota-shi Aichi-ken (JP)

(21) Appl. No.: 19/226,584

(22) Filed: Jun. 3, 2025

(30) Foreign Application Priority Data
Jun. 10, 2024 (JP) 2024-093676

(51) Int. Cl. G06V 20/58; G06T 3/047; G06T 11/00; G06V 10/774

(52) U.S. Cl. CPC G06V 20/58; G06T 3/047; G06T 11/00; G06V 10/7747

(57) ABSTRACT

A learning image generation device generates a learning fisheye image for use in learning of a model used for an estimation of a state of a trailer based on a fisheye image shot by a camera mounted on a vehicle towing the trailer via a tow bar, acquires an original learning fisheye image shot by a learning camera mounted on a learning vehicle towing a learning trailer via a learning tow bar, generates a planar orthogonalization transformation image by executing planar orthogonalization transformation on the original learning fisheye image, adds virtual road surface paint to the planar orthogonalization transformation image, and generates the learning fisheye image by executing inverse transformation of the planar orthogonalization transformation on the planar orthogonalization transformation image after the virtual road surface paint is added (planar image having the virtual road surface paint).

### CROSS-REFERENCE TO RELATED APPLICATIONS

This application claims priority to Japanese Patent Application No. 2024-093676 filed Jun. 10, 2024, the entire contents of which are herein incorporated by reference.

### FIELD

The present disclosure relates to a learning image generation device, a learning image generation method, and a non-transitory recording medium.

### BACKGROUND

PTL 1 (JP-A-2018-176788) describes a tow vehicle in which an imaging unit having a wide-angle lens or a fisheye lens is provided on a wall below a rear hatch. PTL 1 also describes that image data shot by the imaging unit can be used to detect the connection state (for example, the connection angle, whether the tow vehicle is connected to a towed vehicle, etc.) between the tow vehicle and the towed vehicle.

Though PTL 1 describes that the connection state of the tow vehicle and the towed vehicle is detected by image processing, whether a model which requires learning is used in the image processing is not described. If the model is used to detect the connection state of the tow vehicle and the towed vehicle, it is necessary to suppress an increase in the load of preparing learning data used for learning the model.

### SUMMARY

In light of the foregoing, an object of the present disclosure is to provide a learning image generation device, a learning image generation method, and a non-transitory recording medium which enable learning of a model using a fisheye image including road surface paint as learning data without the need to actually shoot a fisheye image including road surface paint using a learning camera.
(1) An aspect of the present disclosure provides a learning image generation device including a processor configured to: generate a learning fisheye image as learning data for use in learning of a model used for an estimation of a state of a trailer based on a fisheye image shot by a camera mounted on a vehicle towing the trailer via a tow bar; acquire an original learning fisheye image shot by a learning camera mounted on a learning vehicle towing a learning trailer via a learning tow bar; generate a planar orthogonalization transformation image by executing planar orthogonalization transformation, which is transformation of the fisheye image to a planar image, on the original learning fisheye image; add virtual road surface paint to the planar orthogonalization transformation image; and generate the learning fisheye image by executing inverse transformation of the planar orthogonalization transformation on a planar image having the virtual road surface paint, which is the planar orthogonalization transformation image after the virtual road surface paint is added.
(2) An aspect of the present disclosure provides a learning image generation method including: generating a learning fisheye image as learning data for use in learning of a model used for an estimation of a state of a trailer based on a fisheye image shot by a camera mounted on a vehicle towing the trailer via a tow bar; acquiring an original learning fisheye image shot by a learning camera mounted on a learning vehicle towing a learning trailer via a learning tow bar; generating a planar orthogonalization transformation image by executing planar orthogonalization transformation, which is transformation of the fisheye image to a planar image, on the original learning fisheye image; and adding virtual road surface paint to the planar orthogonalization transformation image, wherein the learning fisheye image is generated by executing inverse transformation of the planar orthogonalization transformation on a planar image having the virtual road surface paint, which is the planar orthogonalization transformation image after the virtual road surface paint is added.
(3) An aspect of the present disclosure provides a non-transitory recording medium having recorded thereon a computer program for causing a processor to perform a process including: generating a learning fisheye image as learning data for use in learning of a model used for an estimation of a state of a trailer based on a fisheye image shot by a camera mounted on a vehicle towing the trailer via a tow bar; acquiring an original learning fisheye image shot by a learning camera mounted on a learning vehicle towing a learning trailer via a learning tow bar; generating a planar orthogonalization transformation image by executing planar orthogonalization transformation, which is transformation of the fisheye image to a planar image, on the original learning fisheye image; and adding virtual road surface paint to the planar orthogonalization transformation image, wherein the learning fisheye image is generated by executing inverse transformation of the planar orthogonalization transformation on a planar image having the virtual road surface paint, which is the planar orthogonalization transformation image after the virtual road surface paint is added.

According to the present disclosure, it is possible to enable learning of a model using a fisheye image including road surface paint as learning data without the need to actually shoot a fisheye image including road surface paint using a learning camera.

### BRIEF DESCRIPTION OF DRAWINGS

FIG. 1 is a view showing an example of a learning image generation device 1 of a first embodiment.

FIG. 2A is a view showing an example of a learning vehicle L1 on which a learning camera L11 is mounted and the like.

FIG. 2B is a view showing an example of an original learning fisheye image IM1 shot by the learning camera L11.

FIG. 3A is a view showing an example of a planar orthogonalization transformation image IM2 generated by an image transformation unit 3B.

FIG. 3B is a view showing an example of virtual road surface paint VP (compartment line) added by an addition unit 3C to the planar orthogonalization transformation image IM2 shown in FIG. 3A.

FIG. 3C is a view showing an example of a planar image IM3 having virtual road surface paint, which is the planar orthogonalization transformation image after virtual road surface paint VP (compartment line) is added by the addition unit 3C.

FIG. 4 is a view showing an example of a learning fisheye image IM4 generated by a learning image generation unit 3D.

FIG. 5 is a view for explaining a state of a trailer R2 (hitch angle Φ of the trailer R2) estimated by using a model, learning of the model is performed by using the learning fisheye image IM4 having the virtual road surface paint VP (compartment line) generated by the learning image generation unit 3D of the learning image generation device 1 as learning data.

FIG. 6 is a flowchart for explaining an example of a process executed by the learning image generation device 1 of the first embodiment.

### DESCRIPTION OF EMBODIMENTS

Embodiments of learning image generation device, learning image generation method, and non-transitory recording medium of the present disclosure will be described below with reference to the drawings.

### First Embodiment

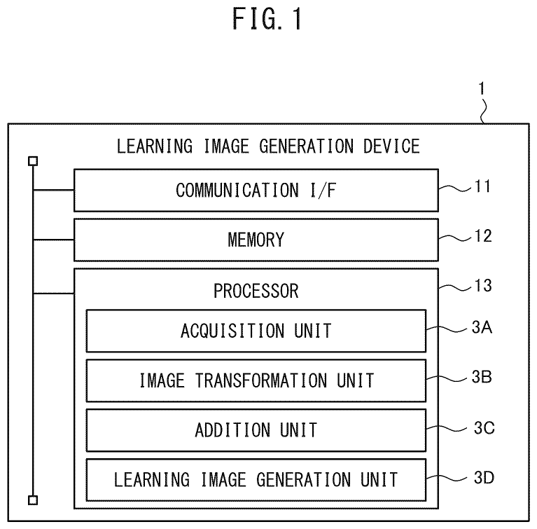

FIG. 1 is a view showing an example of a learning image generation device 1 of a first embodiment.

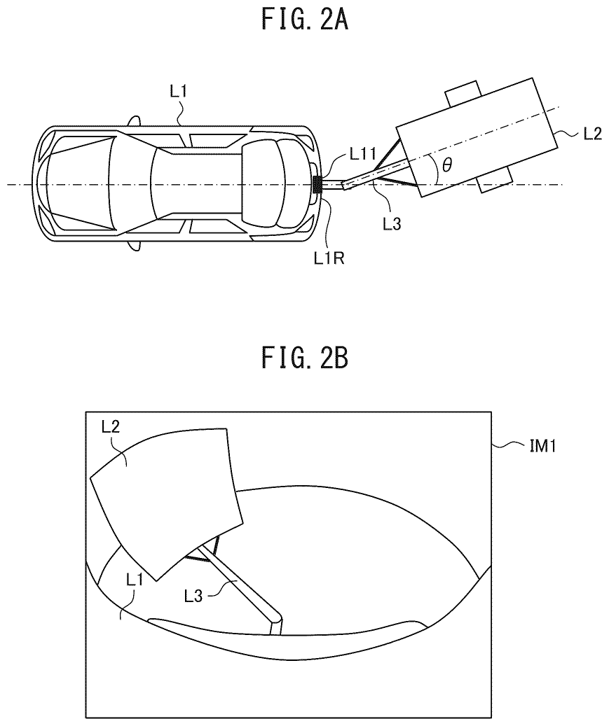

In the example shown in FIG. 1, the learning image generation device 1 is configured by a microcomputer including a communication interface (I/F) 11, a memory 12, and a processor 13. The communication interface 11 has an interface circuit for connecting the learning image generation device 1 to a device external to the learning image generation device 1 (for example, a storage device (not shown) for storing an original learning fisheye image IM1 (refer to FIG. 2B) shot by a learning camera L11 (refer to FIG. 2A)).

FIG. 2A and FIG. 2B are views showing an example of a learning vehicle L1 on which the learning camera L11 is mounted and the like. In detail, FIG. 2A shows the example of the learning vehicle L1 on which the learning camera L11 is mounted and the like, and FIG. 2B shows an example of the original learning fisheye image IM1 shot by the learning camera L11.

In the example shown in FIG. 2A and FIG. 2B, the learning camera L11 is arranged at a rear end L1R of the learning vehicle L1. The learning camera L11 shoots the rear (right side in FIG. 2A) of the learning vehicle L1. As shown in FIG. 2A, the learning vehicle L1 tows a learning trailer L2 via a learning tow bar L3. The learning trailer L2 is connected to the learning vehicle L1 so as to be rotatable about a hitch ball (not shown). As shown in FIG. 2B, the original learning fisheye image IM1 includes a part of the learning vehicle L1, the learning trailer L2, and the learning tow bar L3.

Conversely, in the example shown in FIG. 2A and FIG. 2B, as shown in FIG. 2A, no compartment line as road surface paint is painted on the road surface on which the learning vehicle L1 and the learning trailer L2 are traveling, and as shown in FIG. 2B, the compartment line as the road surface paint is not included in the original learning fisheye image IM1.

In the example shown in FIG. 1, the memory 12 stores a program used in a process executed by the processor 13 and various data. The processor 13 has a function as an acquisition unit 3A, a function as an image transformation unit 3B, a function as an addition unit 3C, and a function as a learning image generation unit 3D.

The acquisition unit 3A acquires the original learning fisheye image IM1 shot by the learning camera L11. In detail, the acquisition unit 3A acquires the original learning fisheye image IM1, which does not include the road surface paint such as the compartment line, for example, as shown in the example of FIG. 2B.

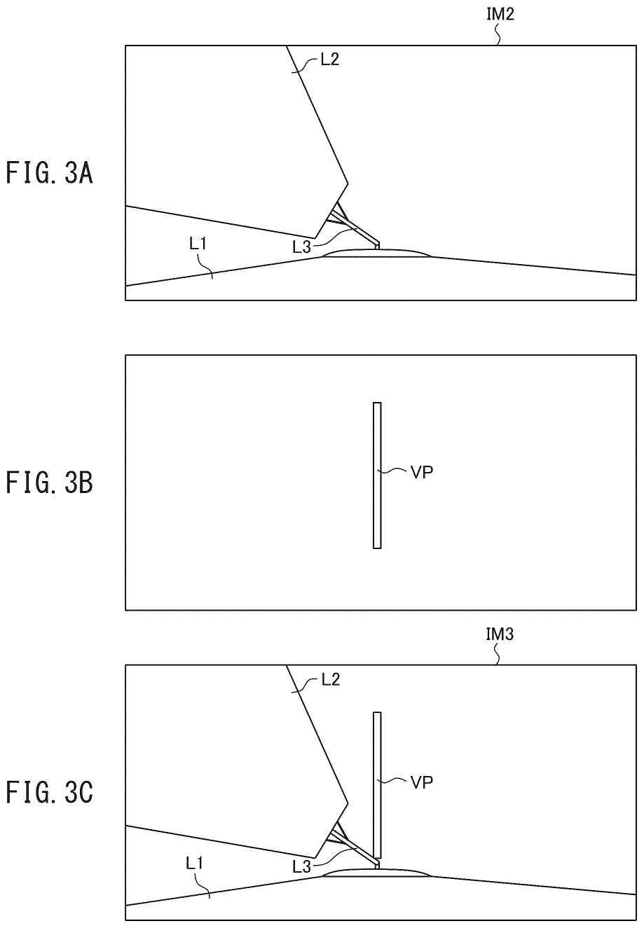

The image transformation unit 3B generates a planar orthogonalization transformation image IM2 (refer to FIG. 3A) by executing planar orthogonalization transformation, which is transformation of a fisheye image to a planar image, on the original learning fisheye image IM1 acquired by the acquisition unit 3A.

The addition unit 3C generates a planar image IM3 having virtual road surface paint (refer to FIG. 3C) by adding the virtual road surface paint VP (compartment line) (refer to FIG. 3B) to the planar orthogonalization transformation image IM2 generated by the image transformation unit 3B.

FIG. 3A to FIG. 3C are views showing an example of the planar orthogonalization transformation image IM2 generated by the image transformation unit 3B, etc. In detail, FIG. 3A shows the example of the planar orthogonalization transformation image IM2 generated by the image transformation unit 3B, FIG. 3B shows an example of virtual road surface paint VP (compartment line) added by the addition unit 3C to the planar orthogonalization transformation image IM2 shown in FIG. 3A, and FIG. 3C shows an example of the planar image IM3 having the virtual road surface paint, which is the planar orthogonalization transformation image after the virtual road surface paint VP (compartment line) is added by the addition unit 3C.

In the example shown in FIG. 3A to FIG. 3C, the addition unit 3C combines the planar orthogonalization transformation image IM2 shown in FIG. 3A with the virtual road surface paint VP (compartment line) shown in FIG. 3B to generate the planar image IM3 having the virtual road surface paint shown in FIG. 3C.

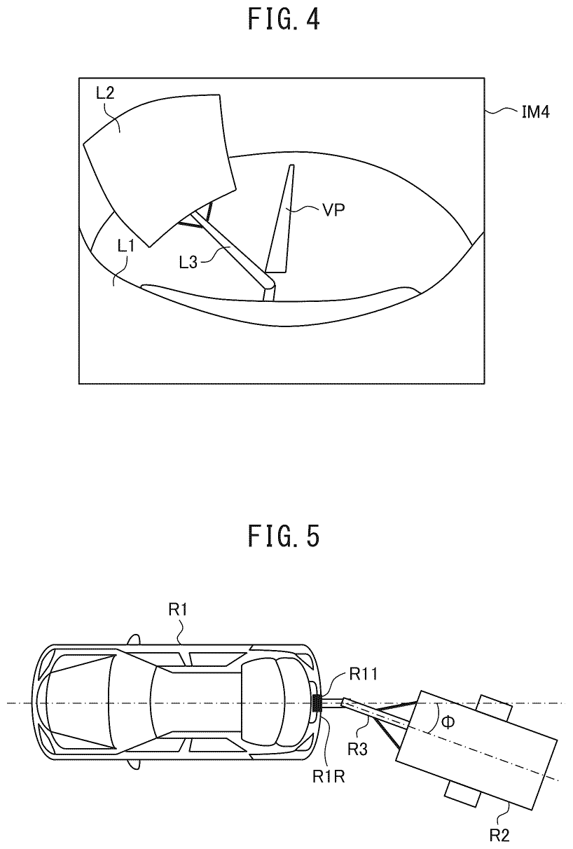

In the example shown in FIG. 1, the learning image generation unit 3D generates a learning fisheye image IM4 (refer to FIG. 4) including the virtual road surface paint VP (compartment line) by executing inverse transformation of the planar orthogonalization transformation executed by the image transformation unit 3B on the planar image IM3 having the virtual road surface paint. FIG. 4 is a view showing an example of the learning fisheye image IM4 generated by the learning image generation unit 3D.

In the example shown in FIG. 4, the learning image generation unit 3D executes the inverse transformation of the planar orthogonalization transformation on the planar image IM3 having the virtual road surface paint shown in FIG. 3C, and generates the learning fisheye image IM4 including the virtual road surface paint VP (compartment line).

As described above, in the examples shown in FIG. 1 to FIG. 4, the learning vehicle L1 and the learning trailer L2 need not actually travel on the road surface on which road surface paint (compartment line) is painted, and the learning fisheye image IM4 including the compartment line (virtual road surface paint VP) can be obtained in the same manner as when the learning vehicle L1 and the learning trailer L2 actually travel on the road surface on which road surface paint (compartment line) is painted. Specifically, in the examples shown in FIG. 1 to FIG. 4, it is possible to enable learning of a model using a fisheye image including road surface paint (compartment line) as learning data without the need to actually shoot a fisheye image including road surface paint (compartment line) using the learning camera L11.

In one application example of the learning image generation device 1 of the first embodiment, the learning fisheye image IM4 including the virtual road surface paint VP (compartment line) generated by the learning image generation unit 3D of the learning image generation device 1 is used as learning data for learning of a model, the model is used to estimate a state of a trailer R2 (for example, hitch angle Φ of the trailer R2) based on a fisheye image shot by a camera R11 (refer to FIG. 5) mounted on a vehicle R1 (refer to FIG. 5) towing the trailer R2 (refer to FIG. 5) via a tow bar R3 (refer to FIG. 5).

FIG. 5 is a view for explaining the state of the trailer R2 (hitch angle Φ of the trailer R2) estimated by using the model, learning of the model is performed by using the learning fisheye image IM4 having the virtual road surface paint VP (compartment line) generated by the learning image generation unit 3D of the learning image generation device 1 as learning data.

In the example shown in FIG. 5, the camera R11 is arranged at a rear end R1R of the vehicle R1. The camera R11 shoots the rear (right side in FIG. 5) of the vehicle R1. The vehicle R1 tows the trailer R2 via the tow bar R3. The trailer R2 is connected to the vehicle R1 so as to be rotatable about a hitch ball (not shown). The fisheye image shot by the camera R11 includes a part of the vehicle R1, the trailer R2, and the tow bar R3.

In one application example (example shown in FIG. 1 to FIG. 5) of the learning image generation device 1 of the first embodiment, the hitch angle Φ of the trailer R2 is estimated based on the fisheye image (image including the trailer R2, etc.) shot by the camera R11 (refer to FIG. 5) by using a model obtained by performing learning using learning data, which is a data set of the learning fisheye image IM4 including the virtual road surface paint VP (compartment line) generated by the learning image generation unit 3D of the learning image generation device 1 and a label indicating the hitch angle θ (refer to FIG. 2A) of the learning trailer L2 at the time of shoot of the original learning fisheye image IM1 (refer to FIG. 2B) corresponding to the learning fisheye image IM4.

In detail, for the learning of the model, the data set of the learning fisheye image IM4 including the virtual road surface paint VP (compartment line) and the label indicating the hitch angle θ (refer to FIG. 2A) of the learning trailer L2 at the time of shoot of the original learning fisheye image IM1 corresponding to the learning fisheye image IM4 is used as the learning data, and a dataset of the original learning fisheye image IM1 not including the virtual road surface paint VP (compartment line) and a label indicating the hitch angle θ (refer to FIG. 2A) of the learning trailer L2 at the time of shoot of the original learning fisheye image IM1 is also used as the learning data.

In the application example (example shown in FIG. 1 to FIG. 5) of the learning image generation device 1 of the first embodiment, the learning fisheye image IM4 including the virtual road surface paint VP (compartment line) generated by the learning image generation unit 3D of the learning image generation device 1 is used for the learning of the model used to estimate the hitch angle Φ of trailer R2, but in another application example, the learning fisheye image IM4 including the virtual road surface paint VP (compartment line) may be used for learning of a model used to estimate a state of the trailer R2 other than the hitch angle Φ of the trailer R2, such as the position (coordinates) of the ends (left end and right end) of the trailer R2.

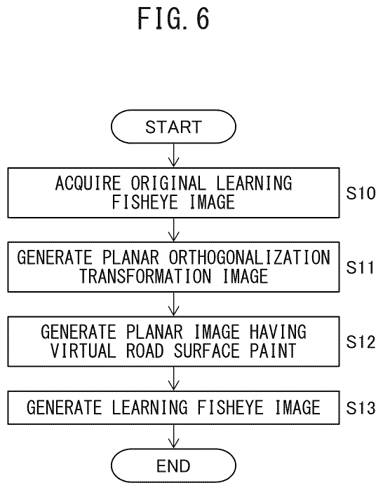

FIG. 6 is a flowchart for explaining an example of a process executed by the learning image generation device 1 of the first embodiment.

In the example shown in FIG. 6, at step S10, the acquisition unit 3A acquires the original learning fisheye image IM1, which does not include the road surface paint (compartment line), shot by the learning camera L11.

At step S11, the image transformation unit 3B generates the planar orthogonalization transformation image IM2 by executing the planar orthogonalization transformation on the original learning fisheye image IM1 acquired at step S10.

At step S12, the addition unit 3C generates the planar image IM3 having the virtual road surface paint by adding the virtual road surface paint VP (compartment line) to the planar orthogonalization transformation image IM2 generated at step S11.

At step S13, the learning image generation unit 3D executes the inverse transformation of the planar orthogonalization transformation executed at step S11 on the planar image IM3 having virtual road surface paint to generate the learning fisheye image IM4 including the virtual road surface paint VP (compartment line).

### Second Embodiment

As described above, in the first embodiment (example shown in FIG. 1 to FIG. 6), the acquisition unit 3A acquires the original learning fisheye image IM1, which does not include the road surface paint such as the compartment line or the like.

Conversely, in a second embodiment, the acquisition unit 3A acquires the original learning fisheye image IM1, which does not include road markings (in detail, road markings such as maximum speed, no turn, left turn arrow, straight arrow, right turn arrow, etc.) as the road surface paint.

As described above, in the first embodiment (the example shown in FIG. 1 to FIG. 6), the addition unit 3C generates the planar image IM3 having the virtual road surface paint by adding the virtual road surface paint VP (compartment line) to the planar orthogonalization transformation image IM2 generated by the image transformation unit 3B.

Conversely, in the second embodiment, the addition unit 3C generates the planar image IM3 having the virtual road surface paint by adding the virtual road surface paint VP (road markings) to the planar orthogonalization transformation image IM2 generated by the image transformation unit 3B.

As described above, in the first embodiment (the example shown in FIG. 1 to FIG. 6), the learning image generation unit 3D generates the learning fisheye image IM4 including the virtual road surface paint VP (compartment line) by executing the inverse transformation of the planar orthogonalization transformation executed by the image transformation unit 3B on the planar image IM3 having the virtual road surface paint.

Conversely, in the second embodiment, the learning image generation unit 3D generates the learning fisheye image IM4 including the virtual road surface paint VP (road markings) by executing the inverse transformation of the planar orthogonalization transformation executed by the image transformation unit 3B on the planar image IM3 having the virtual road surface paint.

In the second embodiment, the learning vehicle L1 and the learning trailer L2 need not actually travel on the road surface on which road surface paint (road markings) is painted, and the learning fisheye image IM4 including the road markings (virtual road surface paint VP) can be obtained in the same manner as when the learning vehicle L1 and the learning trailer L2 actually travel on the road surface on which the road surface paint (road markings) is painted. Specifically, in the second embodiment, it is possible to enable learning of a model using a fisheye image including road surface paint (road markings) as learning data without the need to actually shoot a fisheye image including road surface paint (road markings) using the learning camera L11.

As described above, although the embodiments of the learning image generation device, the learning image generation method, and the non-transitory recording medium of the present disclosure have been described with reference to the drawings, the learning image generation device, the learning image generation method, and the non-transitory recording medium of the present disclosure are not limited to the embodiments described above, and may be appropriately changed without departing from the scope of the present disclosure. The configuration of each example of the embodiments described above may be appropriately combined. In each example of the above-described embodiments, the process performed by the learning image generation device 1 has been described as software process performed by executing the program, but the process performed by the learning image generation device 1 may be process performed by hardware. Alternatively, the process performed by the learning image generation device 1 may be process performed by a combination of both software and hardware. Further, the program (program for realizing the functions of the processor 13 of the learning image generation device 1) stored in the memory 12 of the learning image generation device 1 may be recorded in a computer-readable storage medium (non-transitory recording medium) such as semiconductor memory, magnetic recording medium, optical recording medium, or the like for providing, distribution or the like.

1. A learning image generation device comprising a processor configured to:
generate a learning fisheye image as learning data for use in learning of a model used for an estimation of a state of a trailer based on a fisheye image shot by a camera mounted on a vehicle towing the trailer via a tow bar;
acquire an original learning fisheye image shot by a learning camera mounted on a learning vehicle towing a learning trailer via a learning tow bar;
generate a planar orthogonalization transformation image by executing planar orthogonalization transformation, which is transformation of the fisheye image to a planar image, on the original learning fisheye image;
add virtual road surface paint to the planar orthogonalization transformation image; and
generate the learning fisheye image by executing inverse transformation of the planar orthogonalization transformation on a planar image having the virtual road surface paint, which is the planar orthogonalization transformation image after the virtual road surface paint is added.

2. A learning image generation method comprising:
generating a learning fisheye image as learning data for use in learning of a model used for an estimation of a state of a trailer based on a fisheye image shot by a camera mounted on a vehicle towing the trailer via a tow bar;
acquiring an original learning fisheye image shot by a learning camera mounted on a learning vehicle towing a learning trailer via a learning tow bar;
generating a planar orthogonalization transformation image by executing planar orthogonalization transformation, which is transformation of the fisheye image to a planar image, on the original learning fisheye image; and
adding virtual road surface paint to the planar orthogonalization transformation image, wherein
the learning fisheye image is generated by executing inverse transformation of the planar orthogonalization transformation on a planar image having the virtual road surface paint, which is the planar orthogonalization transformation image after the virtual road surface paint is added.

3. A non-transitory recording medium having recorded thereon a computer program for causing a processor to perform a process comprising:
generating a learning fisheye image as learning data for use in learning of a model used for an estimation of a state of a trailer based on a fisheye image shot by a camera mounted on a vehicle towing the trailer via a tow bar;
acquiring an original learning fisheye image shot by a learning camera mounted on a learning vehicle towing a learning trailer via a learning tow bar;
generating a planar orthogonalization transformation image by executing planar orthogonalization transformation, which is transformation of the fisheye image to a planar image, on the original learning fisheye image; and
adding virtual road surface paint to the planar orthogonalization transformation image, wherein
the learning fisheye image is generated by executing inverse transformation of the planar orthogonalization transformation on a planar image having the virtual road surface paint, which is the planar orthogonalization transformation image after the virtual road surface paint is added.
